(19) United States
(12) Patent Application Publication
(10) Pub. No.: US 2026/0317121 A1
(43) Pub. Date: Oct. 15, 2026

(54) METHOD AND SYSTEM OF COMMISSIONING DIAGNOSIS FOR COMPONENTS OF A PASSENGER CONVEYOR SYSTEM

(71) Applicant: Kone Corporation, Helsinki (FI)

(72) Inventors: Matti MUSTONEN, Helsinki (FI); Tom Lindstrom, helsinki (FI); Tommi Nyberg, Helsinki (FI)

(73) Assignee: Kone Corporation, Helsinki (FI)

(21) Appl. No.: 19/402,033

(22) Filed: Nov. 26, 2025

(30) Foreign Application Priority Data
Jan. 9, 2025 (EP) 25150892.5

(51) Int. Cl. B66B 5/00; B66B 1/34; B66B 19/00; B66B 25/00; G01M 99/00

(52) U.S. Cl. CPC B66B 5/0018; B66B 1/3461; B66B 5/0037; B66B 19/00; B66B 25/006; G01M 99/008

(57) ABSTRACT

The invention is about a method and system of commissioning a passenger conveyor system after installation of at least one of its component. The system comprising a diagnostic unit communicatively coupled to and configured to monitor the at least one installed component, and a control system configured to operate the system, wherein the method comprising the automated execution of the following steps for auditing the operation of the at least one installed component by means of a computing unit before taking the component into normal use. First, a running sequence of operation of the at least one installed component is started; Then acquiring parametrized measurement data being receivable in relation to the condition and/or the operation of the at least one installed system component during the running sequence; Transferring the measuring data to the diagnostic unit; Setting one or more limit values for the parametrized measuring data as acquired and defining therewith a desired performance range of the at least one component; Determining by the diagnostic unit the extent to which the acquired measurement data extend the defined performance range beyond the one or more limit values; And issuing an electronic report indicating the determination result.

### RELATED APPLICATIONS

This application claims priority to European Patent Application No. EP25150892.5 filed on Jan. 9, 2025, the entire contents of which are incorporated herein by reference.

### FIELD OF THE INVENTION

The present invention relates to the field of passenger conveyor systems like elevator systems, escalator systems or auto-walk-systems (=travelator) being set up of several components along with sub-systems, respectively, and in particular the invention relates to their commissioning after installation of such component(s), respectively. The present invention therewith relates in detail to a method for checking functional capability and operational readiness of at least one component or at least one sub-system of such passenger conveyor system following to its/their installation.

### BACKGROUND OF THE INVENTION

Any of those passenger conveyor systems may be considered in general as a distributed mechatronic system. Taking for example an elevator, the same includes an elevator car and possibly a counterweight, wherein the elevator car and the counterweight are suspended in an elevator shaft by suspension means or supported by any hydraulic mechanism. To such systems a plurality of mechanical and electrical components belongs, being arranged inter alia along the elevator shaft. All these elevator components may contribute in various elevator functions, such as guiding any elevator car movement in the elevator shaft, measuring an elevator car position, lighting an elevator system, suspending the elevator car, driving the elevator car, controlling the elevator system, transferring data within the elevator system and/or with an entity external to an elevator system, interfacing with an elevator user, ensuring safety of the elevator system, and braking and/or arresting an elevator car movement, etc.. Among such elevator components are elevator doors, door drive units, guiderails, fixing brackets, hoisting ropes, traction sheaves, electrical motors, encoders, bearings, lights, control nodes, user interfaces, data cables, cameras, position measurement targets for measuring an elevator car position, safety switches and safety contacts, safety brakes, control cabinets, electrical power units, and various other kind of sensors, actuators and structural components.

Traditionally, after elevator installation has been completed a verification of functional behaviour is carried out to make sure that the elevator operates as intended. Usually, this test operation comprises verifying that the elevator can travel with desired speed and desired ride comfort to all landings and can open doors, such that access from each landing floor to an elevator car is possible in a safe way.

When for example elevator doors are assembled and attached to the shaft walls or landing door openings, the drilling, positioning and alignment of parts is typically done manually which leads to a varying quality in the door operation. Although an installation check is carried out whether or not the new installed door components are within a set function range, the latter still shows said variety in the door operation due to different mounting situations that have to be accepted because every assembly is a bit different.

After a technician has approved the basic functionality, the elevator system is put into operation and then the maintenance monitoring starts afterwords, which evaluates when a component requires maintenance or replacement. Document U.S. Pat. No. 6,439,350B1 for example discloses a maintenance method for checking the operation of an elevator door system, wherein an operating parameter of the door system is measured, and a maintenance message is sent, if an operating parameter exceeds a threshold.

Having now a look to other passenger conveyor systems like escalators or travellators, a plurality of mechanical and electrical components is there also included even when being special for the single system, being for example arranged along the length of the escalator or travellator. All these components may contribute to various operational functions, such as guiding the movement of steps or pallets. Other components are handrails, step chains, drive chains, guide rails, balustrades, comb plates, traction systems, electrical motors, encoders, lights, control nodes, user interfaces, data cables, cameras, position measurement devices, safety switches and safety contacts, safety brakes, control cabinets, electrical power units, and various types of sensors, actuators, and structural elements. When commissioning such system after installation, a functional behaviour is carried out to ensure the system operates as intended. Usually, this test operation includes verifying that the system can operate at the desired speed and ride comfort, and that steps or pallets move seamlessly.

When, for example, comb plates or balustrades are assembled and attached to the structure, the drilling, positioning, and alignment of parts are typically done manually, leading to varying quality in a component operation. Although an installation check is carried out to confirm whether the newly installed components are within a functional range, the system may still exhibit operational variability due to differences in mounting situations.

After a technician has approved the basic functionality, the system is put into operation, and maintenance monitoring begins. This process evaluates when a component requires maintenance or replacement.

### AIM OF THE INVENTION

It is an object of embodiments of the invention to address the above-identified drawbacks. In particular, it is an object of embodiments of the invention to raise the installation quality of a passenger conveyor system's component by improving a commissioning of said component before taking it into normal use.

### SUMMARY OF THE INVENTION

The above object is solved by the subject matter of the independent claims 1, 9, 10, 11 and 13 revealing a method of commissioning at least one component or at least one sub-system belonging to the passenger conveyor system after installation, a method of passenger conveyor installation along with commissioning, a computer program realizing the method steps and a passenger conveyor system, respectively. The dependent claims relate to beneficial embodiments.

The invention as disclosed overcomes the limitations of prior art by providing a method for auditing an installed system component's condition and/or operation by a qualitative measurement before it is taken into normal use. The applied measurement establishes a benchmark for the quality inspection of an installed component, as is possibly performed downstream of the later following maintenance analysis of the component when being in normal use later on. By means of the method's appliance of measuring the component's condition and operation quality, operating marginals in the sense of how much the condition can get worse before a functional failure could happen can be evaluated before the component is taken into normal use.

According to an embodiment of the invention, it also possible to take several components for commissioning together in a unit or multiple units to apply the invented method of commissioning batchwise for unit(s) in succession.

As regards the above cited components as examples, like the elevator doors, door drive units, guiderails, fixing brackets, hoisting ropes, traction sheaves, electrical motors, encoders, bearings, lights, control nodes, user interfaces, data cables, cameras, position measurement targets for measuring an elevator car position, safety switches and safety contacts, safety brakes, control cabinets, electrical power units, handrails, step chains, drive chains, balustrades, comb plates, traction systems, and various other kind of sensors, actuators and structural components, there are components that here can already provide data records per se, as a sensor is installed together with the respective component. In the case of other components that do not have a device for providing data for the method according to the commissioning invention, it is advantageously possible to use sensors and couple them with the respective component, which serve to enable data to be read out on the functioning of the respective component, respectively.

The method utilizes an acquiring unit for gathering the decisive data, a diagnostic unit being communicatively coupled to the component and configured to monitor the installed component, alongside a control system responsible for forwarding results and starting the passenger conveyor system operations during which test data can be gathered. If the installed component belongs to a subsystem of the passenger conveyor system and is assigned to it, the diagnostic unit can query the corresponding operational capability via the subsystem. The diagnostic unit is therefore located on a superordinated level of individual subsystems with which the diagnostic unit can communicate. The proposed method includes a sequence of steps that analyse and verify the component's performance against set limits, which results were conveyed in a digitally issued report.

According to the invention, the sequence of steps is carried out by a computer program as an analytic tool for commissioning the at least one component of a passenger conveyor system.

According to a convenient embodiment these steps are carried out automatically without intervention of a technician fitter. At least, this helps the technician to realize a first starting phase. If this starting phase already shows very good results, the installation process can be accomplished quickly. In case the first results as carried out automatically are not within a range of acceptance, the technician can refine the instructions with the help of his intervention on the instructing computer.

The invention offers a method for numerically estimating an installation quality, allowing installers to detect and rectify issues on-site before concluding the installation process. This leads to passenger conveyors in better condition for regular use, significantly reducing the “First Year Call-Out Rate” and minimizing unnecessary site visits.

Furthermore, the commissioning report is automatically generated and can possibly show analysed consequences like highlighting potential corrective actions (e.g., alignment adjustments) if required, and enabling a rapid re-evaluation of installation quality with a new commissioning sequence.

With the advancements in passenger conveyor diagnostics, modern systems generate large amounts of data that can be used to monitor the condition of subsystems and components and it is precisely this data that is used in accordance with the invention to analyse the condition of an installed component at an early stage of installation. For instance, the average friction of a door system, including car and landing doors, can be quantified, enabling a measurement of operational margins during the commissioning, i.e., on “day zero,” before an elevator is put into regular use. By analysing this data, corrective actions—such as realigning landing doors—can be taken before a final handover to take into normal use.

Following to the mechanical installation of the component(s) under consideration, so-to-say its mounting, the component has to be coupled by connecting it electrically and/or electronically to the main system or its subsystem to realise any data exchange. It must be assumed in this respect that the passenger conveyor system is actually not in a normal operating mode during the time when a new component is installed to the passenger conveyor system.

When starting the method by activating a corresponding application on a computing unit the preceding steps would be to first check any authorisation of the requestor. Such an authorisation encompasses i.a. the required allowance to get access for controlling the passenger conveyor system at least in the specific range to carry out the method of the invention.

Following to a positive outcome of this authorisation process, the method then involves the following sequence of automated steps, which are executed by the computing unit prior to the passenger conveyor system's component being put into normal use. These automated steps are carried out in communication with the system's control unit. Said computing unit can be thus a unit of the controller. However, it can also be a computing unit that is present in a network (cloud), which instructs the passenger conveyor system's controller to execute the steps externally:

Initiating Operation Sequence: The method commences with a start command, triggering a running sequence of operations for the installed component by controlling the component to execute at least one of its functions under controlled conditions. During this phase, the system activates the component for gaining measurement results that are to be acquired by the acquiring unit.

The controlled conditions can deviate from running modes of the component under normal use having the advantage that special test sequences can be run through. These can provide better and more detailed information about the functionality of the component by means of the special measurements obtained therewith as compared to tests under normal operation, only. Said operation sequence for running the component under consideration in special manner can according to an embodiment also include to embed this operation sequence by coupling the same with other entities.

For example, the function of opening and closing a door of an elevator can be embedded in the process of an elevator car arriving at a particular floor. The measurement data for the door movement, which is then used to evaluate the functionality of the door for commissioning the door or a part of it, is therewith embedded in the process of the car movement, which ends with the arrival of the car at a certain floor.

Data Acquisition: As the component runs through its operation sequence, a parameter is calculated by means of collected measurement data that is relevant to the component's condition or operation functionality. This data may include measured values such as friction levels, load variations, vibration, noise or other critical performance parameter(s). From the latter indicators can be calculated that give an easy comprehensive result. These indicators vary individually for each component and must be selected and specified for commissioning. The program must therefore include an instruction for selecting the performance indicators.

Setting Performance Range: The control system sets one or more limit values for the acquired data and/or parameter. These limits establish a desired performance range, a benchmark that represents acceptable operating conditions for the component. By setting these values, the system can detect deviations that may signify potential issues in alignment, installation quality, or component wear.

There are several possibilities for finding such performance range: As an alternative, beside the possibility of testing whether a parameter value lies within a “predefined” range whose limit values are considered “functionally acceptable,” and which limit values are stored, it is also possible to evaluate each individual measurement value to determine how much it deviates from the average value derived from the actual set of all measured values.

For instance, it may occur that an actual measured value or parameter value still falls within the above-defined “functionally acceptable” range but exhibits a singularity by significantly deviating from all other actual values or the average value of the actual dataset.

This approach involves not only assessing absolute compliance with predefined limit values but also incorporating a statistical analysis to identify outliers or anomalies. Such anomalies may signal emerging issues even if the parameter in question does not yet exceed acceptable operational limit values. By comparing individual measurements to the collective dataset, including the mean, median, or other statistical indicators, the system can detect patterns of inconsistency or irregularity.

For example, a parameter might remain within functional limit values but show a persistent or sudden spike that differs significantly from the typical values observed. This could indicate potential wear, misalignment, or other issues developing within the system, which might not yet have reached critical limit values but could degrade performance or cause failure over time if unaddressed.

This method of identifying deviations from the average or expected behaviour adds an additional layer of reliability and foresight to monitoring processes, enabling earlier detection of subtle trends and improving predictive maintenance strategies. It ensures that singularities or unusual values are flagged for further investigation, even when they remain within traditional operational limit values.

A mathematical implementation of this concept could be based on statistical methods that analyse deviations of individual measurements from an average value or other reference values. This can be for example based on first calculating the average value (mean) of all measurements, which represents the central or typical value of the dataset. Next, the variation or spread of the measurements (standard deviation) could be determined, showing how far the individual values deviate from the average on average. A small variation indicates that the measurements are closely grouped, while a larger variation suggests more significant differences.

Each individual measurement is then analysed to determine its deviation from the average. This deviation is compared to the typical variation to identify whether the value is unusual. An acceptable range is defined as “normal” or “functionally acceptable,” and as long as values fall within this range, they are considered unproblematic. However, values outside this range are flagged as potentially problematic.

Even if a value lies within the acceptable range, it is possible for it to deviate significantly from the other values. In such cases, it is identified as an outlier or singularity. This helps detect potential issues early, even if the value does not yet exceed the predefined acceptable limits. This method provides a robust way to identify anomalies and ensure accurate monitoring.

The limit values and/or the performance range may arise or could be assisted from a learning algorithm that is supported by AI-processes running on a computing unit using a trained machine-learning. Said computing unit can be part of a controller at the system's site. Alternatively, the algorithm processes can be accomplished on an extern computing unit, with which the diagnostic unit of the passenger conveyor system (see in the following) is communicatively connected. According to an alternative solution, the limit values can be laid down in a data table of the component to be installed wherein the respective data were loaded automatically when installing the component and coupling the component with the control system and the diagnostic unit of the passenger conveyor system.

Data Transfer to Diagnostic unit: The measurement data and/or the calculated parameter out of it and the established limit values and defined performance range(s) are transmitted to a diagnostic unit. The diagnostic unit is typically located at the device site and is responsible for edge processing tasks such as sampling raw sensor data, performing statistical calculations, and filtering noise.

Extent Determination: Using the diagnostic unit, the method determines the extent to which the measured data falls within, or exceeds, the predefined performance limits. This step allows the system to detect if the component's condition or performance deviates from acceptable thresholds.

According to the diagnostic system as meant in the present invention, there exists a fundamental interplay between the diagnostic unit and a network cloud for monitoring and analysing any system performance. The diagnostic unit as said above is typically located at the device site. Meanwhile, the network cloud offers robust computational resources for higher-level analytics, such as determining whether the system passes or fails certain performance criteria based on the processed data.

In the standard configuration, the diagnostic unit handles initial processing steps. It collects raw sensor data, for instance, electrical current values or encoder pulse signals. This unit then also extracts relevant measurement parameters, such as force or position, and refines them into more meaningful condition data, such as friction, using predefined algorithms. So, edge processing is performed and can be extended to aggregating or averaging these values (e.g., average friction). The refined data can be then communicated with the network cloud, where advanced analytics are applied. The cloud evaluates the data to determine outcomes like whether the system is functioning normally or if it has failed. For example, the cloud might report: “FAIL! Floor 5, Side A: Excessive friction.”. Such solution therewith resembles a hybrid configuration, where pre-processing is conducted locally on the diagnostic unit, and the processed data is transmitted to the cloud for analytics. This setup minimizes the volume of data sent over the network, reducing bandwidth usage while retaining the cloud's advanced analytics capabilities.

However, beyond this standard setup, various configurations can distribute these processing and analytics tasks between the diagnostic unit and the network cloud. The flexibility in such combinations provides opportunities for tailoring system functionality to specific use cases: In one scenario, the analytics could be conducted entirely on the diagnostic unit at the device site. This approach is suitable for systems with limited network connectivity or when real-time, on-site decisions are critical. For instance, the diagnostic unit could compute that excessive friction on Floor 5, Side A, has occurred, triggering an immediate local alert. Conversely, both the pre-processing could be offloaded to the network cloud. In this setup, raw sensor data is transmitted directly to the cloud, where all subsequent data refinement and decision-making occur. This configuration leverages the cloud's vast computational resources and centralized data storage, enabling more complex analysis and trend prediction. However, this approach may introduce latency and is dependent on reliable connectivity.

Report Generation: Based on the analysis, the diagnostic unit generates an electronic report that indicates the extent to which the acquired data aligns with the desired performance range. This report provides a detailed summary of the commissioning outcome, enabling efficient validation or identification of necessary corrective actions.

This aspect can also provide information on past and current issues with the passenger conveyor system, such as recurring faults, signs of wear, previous repairs, and maintenance activities. The aim is to give the technician a comprehensive overview of the passenger conveyor system's condition in view of its component(s). If known issues are identified, the report can also include specific recommendations for addressing them, including components to inspect, appropriate tools, and suggested procedures. Step-by-step instructions can be added if necessary.

According to an advantageous embodiment, the overall commissioning process may be conducted sequentially when installing multiple components. The control system is capable of establishing a commissioning order, wherein each component's commissioning proceeds only if the previous component's measured data remains within its performance range. Such sequencing ensures a comprehensive assessment of the installation, with no component left unchecked. Against this background, the method according to the invention can be used for a complete installation of an entire passenger conveyor system, in which all components belonging to the system are checked step by step. The procedure is repeated until the commissioning test provides a qualitatively satisfactory result.

Passenger conveyor system commissioning then begins with a thorough definition of the system's characteristics, its operational needs, and the customer values required to optimize its parameters. This process takes into account several key aspects. When taking for example an elevator system such a key aspect can be the building and equipment characteristics, such as the type of building, usage patterns, and the specific elevator model; any special requirements of the elevator, the building, or its users, for example, needs for accommodating a tenant with a wheelchair on a particular floor or providing efficient access to a cafeteria on another floor; and the preferences of the customer, which may prioritize performance, comfort, or environmental considerations depending on their needs.

To determine the optimal passenger conveyor system parameters, an advanced algorithm is employed. This algorithm processes inputs derived from the building and equipment characteristics, the special requirements of the system and building, and the customer preferences. It references extensive databases that include recommended parameters and usage patterns, tailoring the outputs to the specific context of the building and its intended passenger conveyor system operations. The algorithm can also integrate a cloud-based simulator, which first models a system performance under the defined parameters, settings, and usage patterns before commissioning. This simulation approach is cost-effective, energy-efficient, and allows rapid evaluation of various configurations. The results of these simulations can be validated further with the physical commissioning sequence test.

The system's commissioning process itself is largely automated, leveraging the parameters defined by the algorithm. This automation ensures precision and consistency, reducing the likelihood of errors during the parameter setting phase. Following this, a rigorous quality test is performed to confirm the passenger conveyor system is operating normally, i.e. in optimal mode. This test follows a predefined sequence. In case several passenger conveyors are included this means evaluating a single conveyor at a time to ensure accuracy. If one conveyor fails the quality test of commissioning, the system generates detailed reports on the test results along with actionable recommendations for rectifying any issues identified during the commissioning process. If it is about commissioning a sub-system that is responsible for several components the sub-system can be tested individually for each component, respectively. Further, if it is about commissioning a sub-system that is responsible for several conveyors, the sub-system can be tested individually for each conveyor, respectively.

This comprehensive approach to passenger conveyor system commissioning ensures that the passenger conveyor system operates at optimal efficiency and performance, aligning with both the technical requirements of the building and the unique preferences of the customer.

Moreover, the report generated by the diagnostic unit may include qualitative performance indicators derived from the commissioning data, enhancing readability and ease of interpretation for installation teams and remote service units.

The diagnostic unit, as described, may also communicate with a remote service unit, allowing commissioning results to be monitored, analysed, and recorded remotely. This communication can be realized in a direct connection or via the elevator controller. This capability facilitates improved oversight and faster response to any installation anomalies.

In another embodiment, the method supports cloud-based processing, where certain analytical or control functions are outsourced to a cloud computing system. The cloud can further oversee the process in real-time, and the results of commissioning can be stored, analysed, or reprocessed by advanced algorithms, including artificial intelligence (AI). This capability enhances diagnostic accuracy by leveraging historical data and machine learning models to interpret component conditions with greater precision.

This invention provides several advantages over prior art solutions. By enabling the automated assessment of each component's operational condition immediately after installation, the method allows for corrective measures to be implemented early. This leads to higher quality installations, reduces the likelihood of early-stage failures, and minimizes the need for corrective maintenance visits after the passenger conveying system is in regular operation.

Furthermore, the invention enables real-time communication of commissioning results to remote unit(s), supporting data-driven insights into installation quality and improving the effectiveness of field installation teams through targeted, data-based feedback.

According to a preferred embodiment the commissioning result is laid down in a memory to keep any test sequence and any test sequence progress in record for any later assessment to recapitulate the operation of any component over its lifetime. Of course, such a report also serves as proof of which tests were carried out on the component. Insofar as the results show that the component is functioning perfectly and in full, any warranty can be easily verified.

According to an aspect of the invention, the same includes a computer program resident on a computer-readable media and comprising a set of instructions arranged to cause the computer unit, or a suite of computers, to perform the computer implemented method steps as described above. According to a convenient embodiment these steps are carried out automatically without intervention of a technician. At least, this helps the technician to realize a first starting phase. If this starting phase already shows very good results, the installation process can be accomplished quickly. In case the first results are not within a range of acceptance, the program is set such to give the technician the possibility to refine the instructions with the help of his intervention on the instructing computer.

As a further aspect there is also a non-transitory computer readable medium storing the above computer program for executing the computer implemented steps for auditing the operation of the at least one installed component by means of a computing unit.

In the following the invention is first described by means of a detailed example for commissioning automatic elevator doors of an elevator as passenger conveyor system. A second example is given with reference to an overall installation of an elevator as the passenger conveyor system. As outlined hereinafter, the method involves a systematic, semi-automated or full-automated, and data-driven approach to establish a quality benchmark for the installation. This benchmark serves to verify the proper installation and functionality of each component, including said exemplifying automatic doors and their components, to ensure reliability before the elevator enters regular use with the door(s) installed.

The fitter technician accesses the commissioning program via the cloud-connection-interface, starts the program with predetermined commissioning sequence(s), reviews the data, and evaluates the system performance. The commissioning sequence can be tailored for different set-ups and there can be several variations of it, and e.g. depending on the measured condition data some steps may be added or removed from the sequence. Algorithms to analyse condition data may be based on expert rules, Artificial Intelligence (AI) or generative AI. Based on the analysis, the fitter technician initiates any necessary corrective actions to ensure the elevator operates optimally. After the ride sequence is completed, the system instructs the elevator control system to sample and send measured data to the cloud. The system then analyses the telemetry data in near-real time, using it to generate a comprehensive commissioning report.

For the following example, there is in the drawings

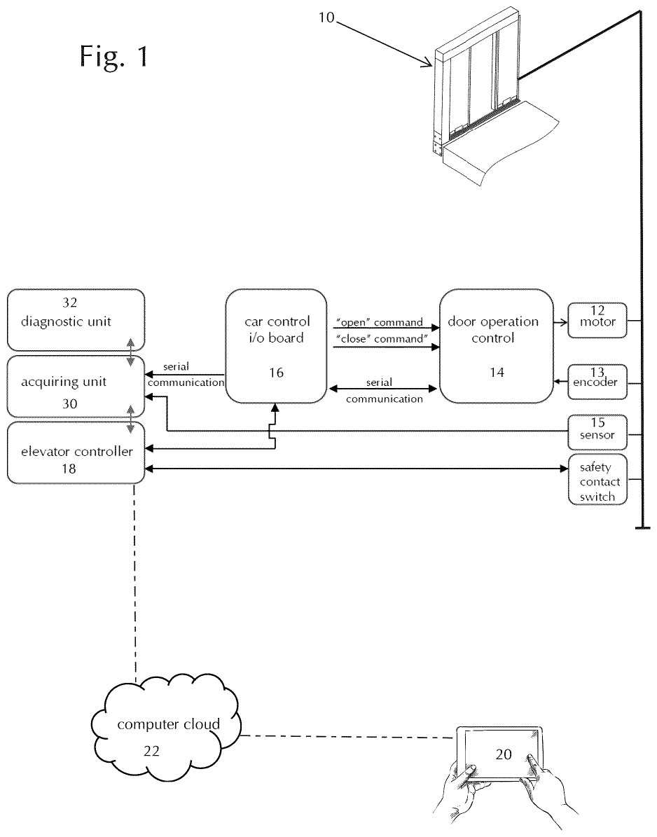

FIG. 1 showing a hardware scheme in accordance with the inventive method steps; and

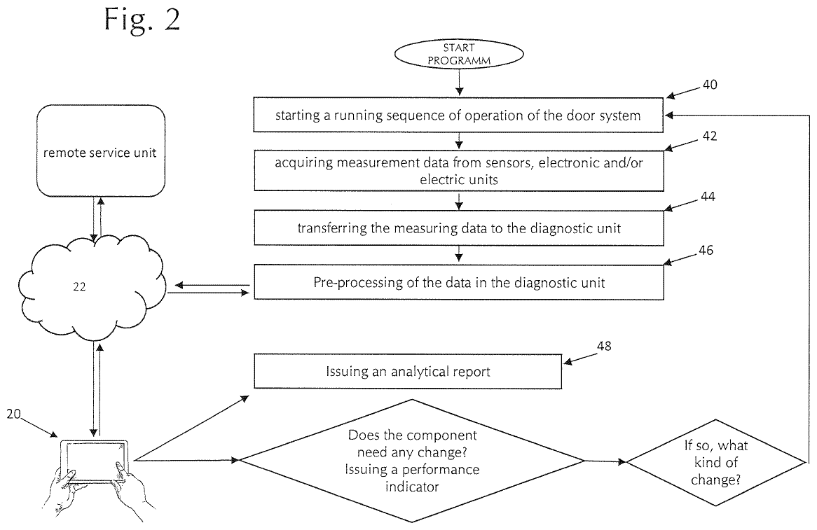

FIG. 2 showing a flow sheet of process steps according to the invention.

The example illustrates the installation of automatic elevator shaft-doors or components thereof as these doors are to be installed on a floor at the opening to an elevator shaft.

The installed door system 10 includes inter alia a motor 12 for moving the door leaf(s), an encoder 13, being taken here as examples out of all components that are relevant when installing a door system, like other components are a roller bearing implementation carrying a door leaf or a lighting system linked to the door system or an instruction panel installed at the floor. As for the roller bearing it is possible to install a vibration sensor that is able to gather data that mirror the quality of function of the roller bearing.

Both the motor 12 and the encoder 13 are connected to a door operation control 14 being a subsystem of the elevator system. A further subsystem is the car control board 16 connected to the door operation control 14 and being an intermediate system to the elevator controller 18 of the entire elevator control system. These subsystems are interconnected by means of a serial communication line (CAN-BUS for example). Via the elevator controller 18 instructions can be sent to open and/or close the doors via this serial communication line to the subsystems, respectively.

The motor 12 and the encoder 13 also provide raw data. The motor's current for example, required for specific actions, can be measured as digital data by the door operation controller 14. This data is utilized to evaluate the actual friction involved in the door-closing and/or door-opening action(s). Additionally, the encoder 13, which counts the motor's rotations, supplies further raw data for assessing this friction. Complementary raw data can also be gathered from a sensor 15 that detects for example vibrations in the rail or roller bearing supporting the door leaf or leaves. A modern elevator can thus produce lots of data from the overall subsystem of automatic doors and/or from a special component of it like the motor or a roller bearing by means of which the doors are moved on a rail or a motor that drives the doors. For example, an average friction of a door system 10 can be estimated from these data by intelligent calculating a numerical parameter in Newtons-unit and thus it is possible to measure these operating margins and the condition of the door system in “day zero”, the commissioning day.

To begin, the doors are manually attached to the shaft walls and landing door openings. This assembly process involves drilling, positioning, and alignment, which are typically done manually. As a result, alignment inconsistencies may occur, leading to variations in door friction related to a specific door system as there are several across different landings. Once physically installed, each door component is electrically and/or electronically connected to the elevator's main control system or its subsystem to control the doors and to enable data exchange. During this initial setup, the elevator is set into a diagnostic mode rather than a normal use mode, ensuring therewith a safe environment for testing.

When having finalized the installation of the doors in view of having mounted the hardware and having connected corresponding components to the serial communication system the inventive method goes further on by instructions as given by a technician responsible for the installation. The technician gets specific access to the elevator system by means of a computer gadget 20 like a laptop, iPad, smart phone or other digital maintenance terminal (like an Android Mini Console) that is connected via a network cloud 22 linking the communication units together for carrying out the method. The handheld computer as digital maintenance terminal can be docketed to the elevator controller 18 by wire, for example by means of USB-connectors. Alternatively and preferably this connection is wirelessly. Connecting is possible through a wireless local area network (WLAN) via a router with internet access; Cellular Network (3G, 4G, 5G), i.e. using mobile data provided by a telecom carrier; Bluetooth (for smaller data transfers or as a bridge to an internet-enabled device); by Wireless Mesh Networks, connecting through a network of wirelessly linked devices or LoRaWAN or Similar IoT Networks being designed for low-power applications, such as IoT devices. The choice depends on speed, range, and availability.

Before the computer implemented commissioning sequence starts with an application on the gadget 20, the system performs an authorization check, verifying that the technician has the required permissions to access and control the elevator system in this commissioning range. This ensures that only qualified personnel initiate the commissioning process. Upon successful authorization, the installer gains temporary access to control elevator components specifically for testing, which access is restricted to the scope that is necessary for any specific commissioning.

The computer implemented part of the commissioning process then starts with a command of the commissioning application, triggering a controlled sequence of operations for the door component(s) to carry out functional tests. The diagnostic sequence program can use special testing conditions, which are different from normal operational parameters. For example, a door opening and closing cycle may be realized with different velocities or may be embedded in the elevator's floor arrival process, allowing real-use scenarios to be simulated under close monitoring. During this controlled operation, sensors and data acquisition systems deliver data by means of which critical parameters like door friction, load variations, vibration, and noise are calculated. These indicators provide essential insights into the component's quality and operational margins. Based on the specific component, the system selects relevant performance indicators, which vary to suit the commissioning requirements of each door.

During this functional tests the measurement data are sent, gathered and laid down in a memory of an acquiring unit 30. Such acquiring unit can be part of the car control board 16 and/or the door operation controller 14 and/or the elevator controller 18.

Once these measurements are fully allocated in the acquiring unit 30, they are transferred to a diagnostic unit 32 where the data can be pre-processed. Said diagnostic unit 32 can be part of or inside the elevator controller 18.

In the example here, there exists a fundamental interplay between a diagnostic unit 32 and a network cloud 22 for monitoring and analysing the system performance. The diagnostic unit is typically located at the device site and is responsible for edge processing tasks such as sampling raw sensor data, performing statistical calculations, and filtering noise. Meanwhile, the network cloud 22 offers robust computational resources for higher-level analytics, such as determining whether the system passes or fails certain performance criteria based on the processed data.

In this standard configuration, the diagnostic unit 32 handles initial processing steps. It collects raw sensor data, for instance, electrical current values or encoder pulse signals. The unit then extracts relevant measurement parameters, such as force or position, and refines them into more meaningful condition data, such as friction, using predefined algorithms. Therewith the edge processing is performed, aggregating or averaging these values (e.g., average friction). The refined data is then sent to the network cloud 22, where advanced analytics are applied. The cloud evaluates the data to determine outcomes like whether the system is functioning normally or if it has failed. For example, the cloud might report: “FAIL! Floor 5, Side A: Excessive friction.”The diagnostic unit 32 for example can further involve limits being established through historical data or machine learning algorithms, representing the desired operating conditions for the specific component. In some instances, AI algorithms can dynamically adjust these thresholds based on real-time data or past installation experiences, refining the acceptable limits to reflect realistic operational demands.

In cases where real-time remote monitoring is possible, the commissioning data can be transmitted to a remote service unit being a unit within the net computing cloud 22, allowing for real-time oversight, analysis, and documentation. This capability enables rapid responses to any anomalies detected during installation. Cloud-based processing realising big data analytics like data as collected from many commissioning and fitter's feedbacks further enhances this approach by handling certain analytical tasks remotely, with real-time results and long-term data storage that aid in future maintenance planning. The cloud-based system also improves diagnostic accuracy through advanced algorithms and historical data interpretation, providing precise insights into each component's condition.

After analysis, an electronic report is generated, summarizing the commissioning results. This report specifies whether the component under test meets performance standards and highlights any areas that may require corrective action, such as realigning a door to reduce friction, for example. The commissioning result is sent both to the remote service unit and to the technician's handheld computer gadget 20.

For elevators with multiple components of the door-subsystem undergoing commissioning, the system sequentially assesses each part, ensuring that one component's commissioning proceeds only if the previous component's performance falls within acceptable parameters. This structured process guarantees a thorough quality check across the elevator system.

The final verification process archives all commissioning data also in the diagnostic unit 32, creating a historical record that captures each component's condition from the time of installation onward. This data serves as proof of the commissioning process, verifying correct installation and providing a baseline for future assessments. Moreover, this record supports warranty verification and maintenance planning, offering insights into the elevator's performance over time.

The entire commissioning process can thus be managed by a computer program, which may reside on a local controller unit or in part of a cloud server. This software controls the commissioning steps and standardizes the assessment process, enhancing quality consistency. By reducing initial failure rates, providing data-driven feedback to installers, and documenting the entire commissioning sequence, this method addresses common challenges in elevator installation and therewith of course also for the hereinafter following maintenance. This data-driven commissioning not only decreases early-stage failures and unnecessary maintenance visits but also sets a high standard for installation quality, improving the elevator's operational reliability.

The process enables real-time reporting to a remote unit, supports data-driven insights into installation quality, and enhances field installation effectiveness by offering targeted feedback based on collected data. Additionally, the commissioning results are stored in a non-transitory medium, keeping a permanent record of test sequences and results, which is invaluable for later assessments and maintenance planning. This method, with its automated assessment capabilities and cloud integration, transforms the commissioning of elevator components into a reliable, consistent, and high-quality process, setting a new standard for installation and early-stage diagnostics.

FIG. 2 shows the process steps in a flowchart. The described method outlines a detailed process for evaluating and commissioning automatic elevator doors as components of the elevator system, ensuring accurate functionality and performance alignment immediately after installation. The process begins with initiating the running sequence of operation 40, triggered by a start command coming from a handheld gadget like laptop, iPad or iPhone or other digital maintenance tool (like Android Mini Console) after authorization for the technician. This involves activating the component under controlled conditions that may differ from normal operating modes. These conditions allow for specialized test sequences that provide enhanced insights into the component's functionality compared to standard operational testing. For example, a door's opening and closing can be tested in conjunction with a car arriving at a specific floor, embedding the door operation within the larger system's functionality.

Data acquisition 42 occurs as the component runs through this sequence. The system collects measurement data such as friction, vibration, and load variations, which are critical performance indicators. These indicators are selected based on the component's commissioning requirements, guided by program instructions.

Next, the process involves data transfer 44 to a diagnostic unit 32, where the gathered data, calculated parameters, and performance limits are analysed. Therewith a pre-processing 46 of data begins. This includes to establish a performance range.

The diagnostic unit then communicates with a network cloud 22, where the system sets benchmark values for the data, using either preloaded data tables, machine-learning algorithms, or AI-supported calculations. These benchmarks define acceptable operational conditions and help identify potential issues like misalignment or component wear. This analysis determines whether the component's performance meets the expected thresholds.

The network cloud 22 is thus summarizing the commissioning outcome and providing actionable insights mirroring advanced capabilities and including cloud-based processing as well as a communication with a remote monitoring service unit, enabling real-time oversight and detailed data analysis. These features leverage AI and historical data to improve diagnostic accuracy and provide installation teams with actionable insights. Results can also be stored for long-term tracking, supporting future assessments of component functionality over its lifespan. The issued report highlights current and past issues, identifies potential faults, and offers step-by-step instructions for corrective measures. If applicable, it also provides recommendations for tools, procedures, and components to inspect.

The method offers numerous advantages, such as reducing early-stage failures, minimizing post-installation corrective maintenance, and enhancing the quality of installations. By keeping comprehensive records of all tests, it provides verifiable proof of successful commissioning and ensures warranty claims are backed by robust documentation.

In the following a further example is described showing an implementation of the inventive method following the installation of an overall elevator system as such.

The elevator controller has been installed with the latest released software and started up for operation. The shaft setup has been completed, allowing the elevator to run at nominal speed in normal mode and stop automatically at designated landings. Automatic tuning has been performed, including the configuration of the speed controller settings and including a calibration of the load weighting device. Additionally, the drive has been fine-tuned to achieve the desired ride comfort class. The elevator car is currently empty, capable of traveling to all landings, and can operate its automatic doors by opening and closing them as required. The elevator is connected to the net computing cloud for data exchange and remote operations.

The commissioning process begins with the elevator being driven to the second-lowest landing it serves. A power cycling operation is performed, where the system is powered off and then powered on again, to clear any existing condition data. The fitter technician being responsible for commissioning then opens and starts the application program of the invention, identifies the elevator under consideration, navigates to the Equipment tab and selects the “Remote commissioning sequence” option from the Remote Operations menu. The system verifies that the commissioning sequence is available for the elevator. Once confirmed, the system initiates a sequence of elevator rides to collect data.

First, the elevator travels to the lowest landing it serves and operates the automatic doors. Subsequently, the elevator travels to all landings it serves in an upward direction, operating the automatic doors at each stop to produce door-related data. This process of traveling and the subsequent door operation is repeated multiple times, such as five cycles, to ensure statistical confidence in the collected data. Next, the elevator runs multiple trips between the terminal floors, again for around five cycles, to generate non-door-related data, including metrics such as average shaft friction and electrical balance. Throughout these sequences, telemetry messages—including car status, door and fault events, and remote command responses—are continuously sent to the cloud.

After the ride sequence is completed, the system instructs the elevator to sample and send measured data to the cloud. The system then analyses the telemetry data in near-real time, using it to generate a comprehensive commissioning report. The fitter technician accesses the commissioning report via the cloud-connection-interface, reviews the data, and evaluates the system performance. Based on the analysis, the fitter technician initiates any necessary corrective actions to ensure the elevator operates optimally. This commissioning sequence can be tailored for different set-ups and there can be several variations of it e.g. depending on the measured condition data some steps may be added or removed from the sequence. Algorithms to analyse condition data may be based on expert rules, Artificial Intelligence (AI) or generative AI.

This solution would bring the benefit of
measuring the installation quality and reacting in an early phase as the commissioning sequence is fast and automated. The installers can initiate the commissioning sequence, wait and check the results to see if something needs to corrected. The commissioning sequence can be repeated if needed to get all checks passed and installation approved;
mapping the results to installation teams and to therewith rate several teams to then be able to select best performing teams for an installation if needed;
minimizing problems during a following maintenance phase since operating margins are as designed because installation quality has been measured and corrected.

### REFERENCE NUMERALS

Door system 10
Motor 12
Encoder 13
Door operation control 14
Sensor 15
Car control board 16
Elevator controller 18
Computer gadget 20
Net computer cloud 22
Acquiring unit 30
Diagnostic unit 32
Starting running sequence 40
Acquiring measurement data 42
Transferring measurement data 44
Pre-processing of the data 46
Issuing analytical report 48

1. A method of commissioning a passenger conveyor system after installation of at least one component of the system, the system comprising a conveyor, a controller configured to operate the passenger conveyor, a data acquiring unit, and a diagnostic unit communicatively coupled to and configured to monitor the at least one installed component, the method comprising the semi-automatic or full-automatic execution of the following computer implemented steps for auditing the operation of the at least one installed component by means of a computing unit before taking the component into normal use:
Starting a running sequence of operation for the at least one installed component by controlling the component to execute at least one of its functions;
Acquiring by the acquiring unit measurement data being receivable in relation to the condition and/or the operation of the at least one installed passenger conveyor system's component during the running sequence;
Transferring the measuring data to the diagnostic unit;
Processing data by the diagnostic unit by setting one or more parameter values, and setting corresponding limit values for the parameter values, respectively, and defining therewith a desired performance range for the at least one component;
Determining by the diagnostic unit the extent to which the acquired measurement data extend the defined performance range beyond the one or more limit values;
Issuing an analytical report indicating the determination result.

2. Method according to claim 1, wherein the passenger conveyor is system is an elevator system or an escalator system or a travellator or a combination of these.

3. Method according to claim 1 being carried out after an installation of several components, wherein the control system is configured to set a sequence order of each commissioning method for each component to be carried out one after the other, wherein the process steps ahead to the next component only in case the preceding component shows the limit values within its desired performance range.

4. Method according to claim 1, wherein the method further comprises the step of transforming the determination result into at least one performance indicator being a qualitative value parameter, and being included in the electronic report.

5. Method according to claim 1, wherein the method further comprises the step of transferring the determination result to a remote service unit being communicatively connected to the system.

6. Method according to claim 1, wherein the control system is connected to a computer net cloud system and wherein at least one step of the automated method is outsourced to be processed by the cloud communicating with the controller.

7. Method according to claim 6, wherein the method is started and/or online-controlled by a computing unit of the cloud system.

8. Method according to claim 1, wherein an analysis of the acquired measurement data is supported by an algorithm of AI (Artificial Intelligence) using a trained machine-learning unit aiding in calculating the determination result and/or aiding in setting the one or more limit values.

9. A computer program resident on a computer-readable media and comprising a set of instructions arranged to cause a computer, or a suite of computers, to perform the computer implemented method steps of claim 1.

10. A non-transitory computer readable medium storing the computer program according to claim 8 for executing the computer implemented steps for auditing the operation of the at least one installed component by means of a computing unit.

11. A method of installing a component in a passenger conveyor system, wherein the conveyor system comprises at minimum a diagnostic unit and a controller configured to operate the conveyor system, wherein the method comprises:
Mounting the component at site as intended for it;
Coupling the component with the controller and the diagnostic unit of the system;
Commissioning the component according to claim 1;
If the commissioning result is such showing a condition and/or operation of the component being out of the desired performance range, then correcting the installation and repeating the commissioning method again.
Forwarding the commissioning result to a remote service unit.

12. Method according to claim 11, wherein the method comprises a continuously forwarding of the commissioning result to the remote service unit.

13. Passenger conveyor system comprising a plurality of components, a controller configured to operate the conveyor system, an acquiring unit configured to gather measurement data related to the condition and/or operation of one or more of the plurality of components, a diagnostic unit communicatively coupled to the acquiring unit, wherein the diagnostic unit comprises a computing unit that is configured to assess performance of the at least one component by determining an extent to which the acquired measurement data go beyond a defined performance range defined by limit values and wherein the elevator system is configured to implement a method according to claim 1.

14. System according to claim 13, wherein the diagnostic unit is further configured to provide an electronic report indicating the determination result of the extent to which the acquired measurement data go beyond the defined performance range and/or at least one performance indicator being a qualitative value parameter for the extent.
